(19) United States
(12) Patent Application Publication
(10) Pub. No.: US 2006/0181654 A1
(43) Pub. Date: Aug. 17, 2006

(54) Projection television

(75) Inventors: Sung-soo Jung, Hwasung-kun (KR); Young-bok Kim, Suwon city (KR); Kyoung-youn Lee, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/739,220

(22) Filed: Dec. 19, 2003

(30) Foreign Application Priority Data
Dec. 23, 2002 (KR) 2002-82448

(51) Int. Cl. H04N 5/64

(52) U.S. Cl. 348/789

(57) ABSTRACT

A projection television having a screen onto which an image beam is projected; a reflector inclinedly disposed at the backside of the screen; a plurality of CRTs disposed at the side of the screen, projecting the image beam toward the reflector; and a plurality of CRT brackets including a body part, CRT inserting parts projecting from the body part and a refrigerant inserting hole formed on one side of the CRT inserting part, and supporting the plurality of CRTs. With this configuration, the present invention provides a projection television wherein the whole dimension of the projection television is reduced, distortion in focus is prevented, the degree of angle between the CRTs and forward and rearward disposition thereof remain stable, and a functional problem due to electromagnetic waves is prevented.

### CROSS-REFERENCE TO RELATED APPLICATIONS

This application claims the benefit of Korean Patent Application No. 2002-082448, filed Dec. 23, 2002, in the Korean Intellectual Property Office, the disclosure of which is incorporated herein by reference.

### BACKGROUND OF THE INVENTION

1. Field of the Invention

The present invention relates to a projection television having a plurality of cathode ray tubes (CRTs) disposed beside a screen, through which image beams are projected, and a plurality of CRT brackets supporting the plurality of CRTs.

2. Description of the Related Art

Generally, a projection television has employed a method of rear projection, wherein images are projected on the backside of the screen.

With the use of the rear projection method, a small-sized image formed on an inner device for projection in the projection television is enlarged on the backside of a large screen through a projection lens, whereby a large picture can be displayed.

In the conventional projection television, a cathode ray tube (CRT), a liquid crystal display (LCD), a digital micro-mirror device (DMD), etc., have been used as a device for projection, so as to supply small images.

Among these projection devices, the CRT has been widely used because it can form pictures from a variety of video sources at a comparatively low price.

Here, the CRT refers to a monochromatic CRT covered with a unicolored fluorescent film in any one of red (R), green (G) or blue (B).

In the projection television employing the CRT, an incidence angle of each CRT, outputting one color of R, G or B, is adapted so that an image is projected on a large screen through a reflector in order to enlarge the picture.

A conventional projection television, as shown in FIGS. 1 and 2, comprises a front casing 1, a rear casing, a speaker 3, a screen 4, a reflector 5, a plurality of CRTs 6, a printed circuit board (PCB) 7, and a controller 8.

The CRTs 6 are provided in three, disposed horizontally in parallel below the screen 4, through which R, G and B are respectively output in monochrome. Generally, the CRTs 6 used as a projection device create typically a picture of 7 to 9 inches.

The picture formed in the CRT 6 generally takes the form of a rectangle, wherein the horizontal edge is longer than the vertical edge. That is, the width has commonly a long side whereas the length has a short side.

The image beam projected in the CRTs 6 is projected with a degree of angle as designated on the reflector 6 disposed with inclination on the backside of the screen 4.

The reflector 5 remains inclined as designated so that the image beam projected from the CRTs 6 disposed below the screen 4 can be reflected on the screen 4. For this purpose, it is preferable that the reflector 5 is first vertically disposed, and thereafter, the top end of the reflector 5 is forwardly inclined toward the screen and then the lower end of the reflector 5 is rearwardly inclined to the contrary.

However, the conventional projection television has the following problems.

First, since the CRTs have been disposed below the screen, a space to dispose the CRTs below the screen has been required. For this reason, the lower part of the front casing has been enlarged in height and the whole dimension of the projection television has been enlarged accordingly.

Second, when the CRT has been horizontally disposed, the picture has been overall lengthened. For this reason, there has been a serious distortion in focus.

Third, the image beams from the plurality of CRTs have varied in the angle of projection, in order to solve the second problem. However, in this case, there has been no satisfactory means for maintaining the designated degree of angle of the plurality of CRTs in a stable manner.

Fourth, since the CRT has been disposed in the same space with the PCB, the heat and electromagnetic waves generated from both the CRT and the PCB have caused a mutual functional problem between them.

Fifth, since the tilting degree of angle between the screen and the CRT has been large, this has required a large amount of adaptation for convergence, thereby having caused power loss and generation of a large amount of heat.

### SUMMARY OF THE INVENTION

Accordingly, it is an aspect of the present invention to provide a projection television wherein the whole dimension of the projection television is reduced, distortion in focus is prevented, the degree of angle between the CRTs and forward and rearward disposition thereof remain stable, and a functional problem due to electromagnetic waves is prevented.

Additional aspects and advantages of the invention will be set forth in part in the description which follows and, in part, will be obvious from the description, or may be learned by practice of the invention.

The foregoing and/or other aspects of the present invention are achieved by providing a projection television, comprising: a screen onto which an image beam is projected; a reflector inclinedly disposed on the backside of the screen; a plurality of CRTs disposed on the side of the screen, projecting the image beam toward the reflector; and a plurality of CRT brackets including a body part, CRT inserting parts projecting from the body part and a refrigerant inserting hole formed on one side of the CRT inserting part, and supporting the plurality of CRTs.

According to an aspect of the invention, the plurality of CRT brackets are formed in an integrated unit.

According to another aspect of the invention, the plurality of CRT brackets are constructed like stairs so that they are inclined in response to the degree of angle for projection of the image beam from the plurality of CRTs.

According to another aspect of the invention, the plurality of CRT brackets are made of a conductive metallic material so as to interrupt EMI.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a conventional projection television;

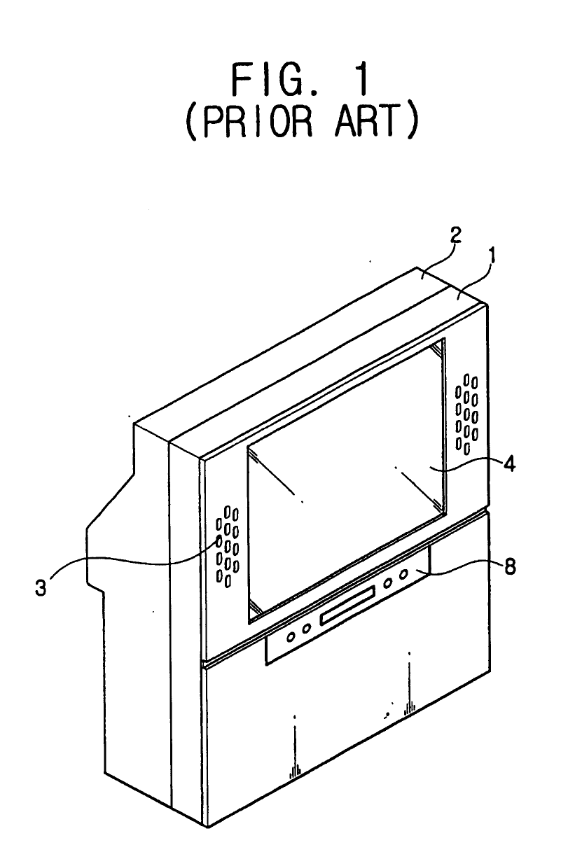

FIG. 2 is an exploded view of a projection television according to FIG. 1;

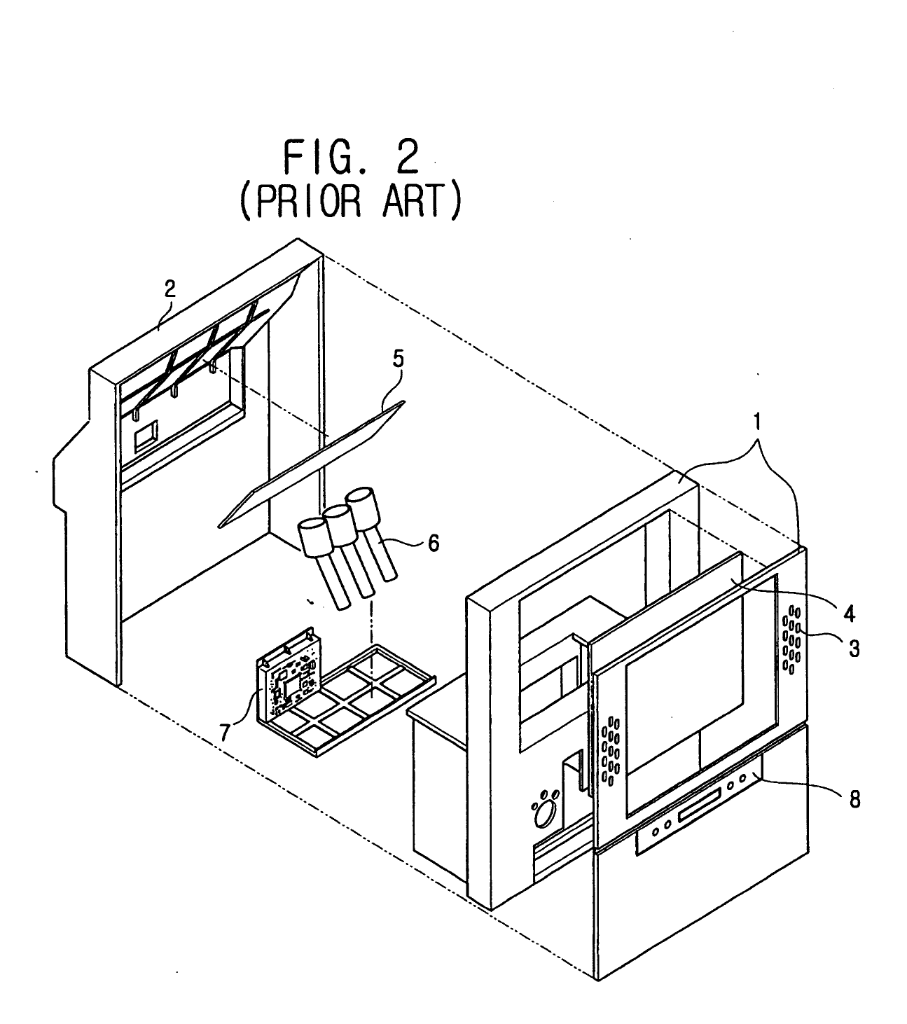

FIG. 3 is a perspective view of a CRT bracket used with a projection television according to an embodiment of the present invention;

FIG. 4 is a front elevational view of the CRT bracket according to FIG. 3;

FIG. 5 is a left side view of the CRT bracket according to FIG. 3;

FIG. 6 is a right side view of the CRT bracket according to FIG. 3;

FIG. 7 is a perspective view showing an insertion of a CRT into the CRT bracket according to FIG. 3;

FIG. 8 is a right side view of the CRT bracket and the CRT according to FIG. 7;

FIG. 9 is a front elevational view showing a disposition of the CRT in the projection television according to an embodiment of the present invention, which is partially projected; and

FIG. 10 is a cross-section view of the projection television according to FIG. 9.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

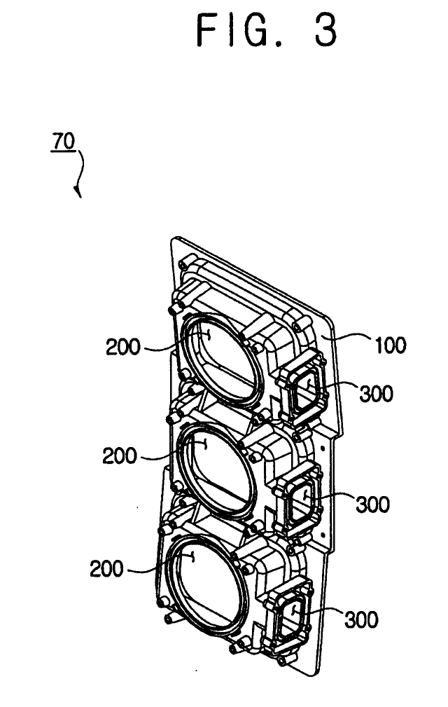

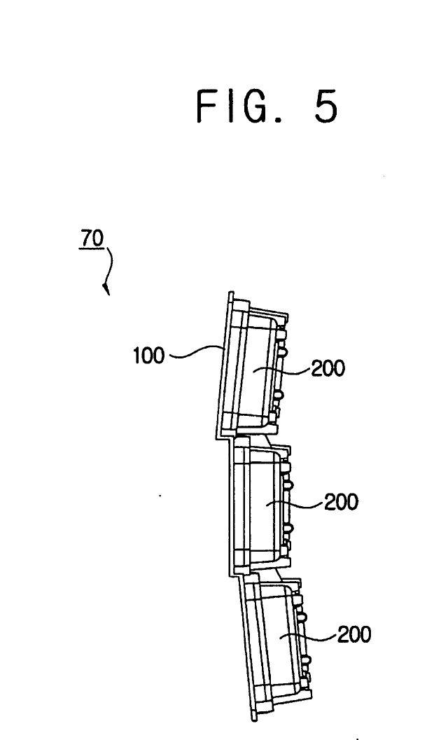

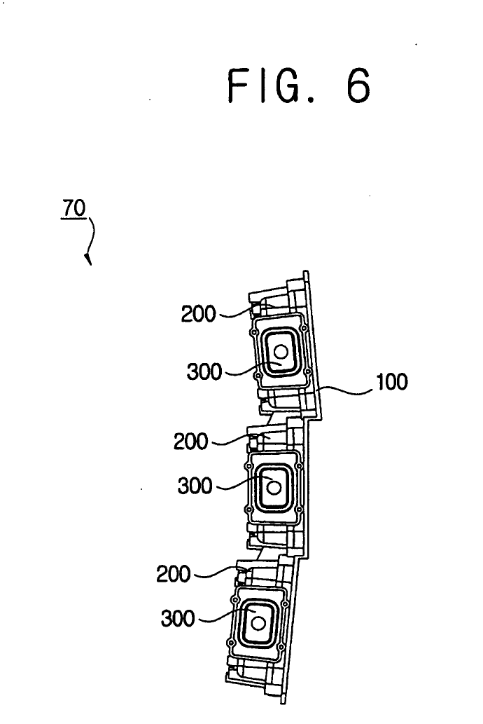

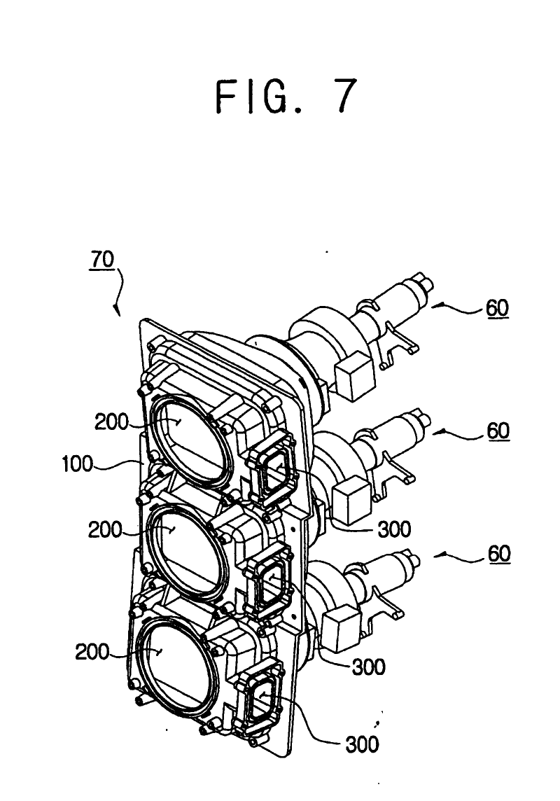

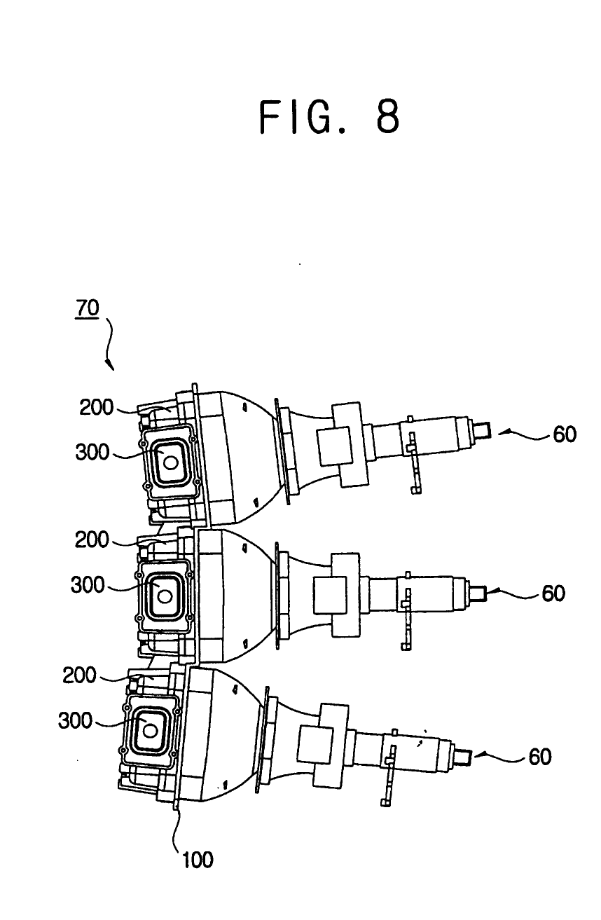

Referring to FIGS. 3 through 9, a projection television according to an embodiment of the present invention comprises a front casing 10, a rear casing 20, a speaker 30, a screen 40, a reflector 50, a plurality of CRTs 60 and a plurality of CRT brackets 70.

The front casing 10 is provided to thereby constitute the front part of the projection television. The front casing 10 includes an upper part on which the screen 40 is seated, and a lower part 13 positioned below the screen, having a controller 15 controlling the projection television.

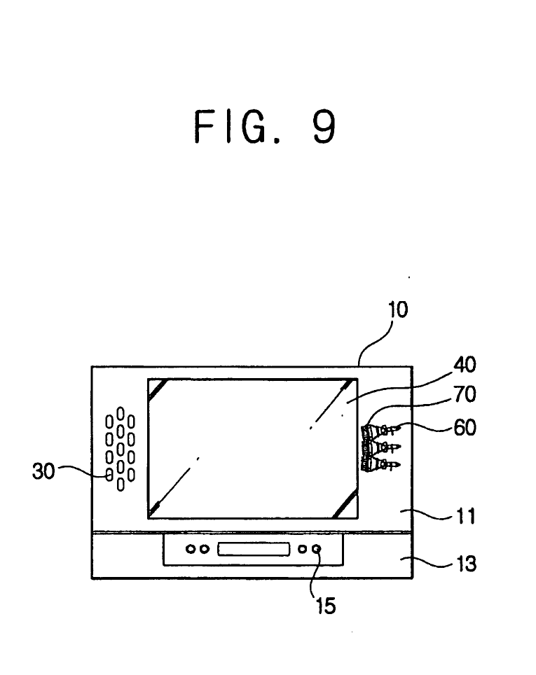

The CRTs 60, as illustrated in FIG. 9, are disposed beside the screen 40. Thus, the lower part 13 of the front casing can be reduced in height.

The rear casing 20 corresponds in shape to the front casing 10. The front casing 10 and the rear casing 20 accommodate therein the speaker 30, the screen 40, the reflector 50, the CRTs 60 and the CRT brackets, among other components functioning as a shield to protect them from external forces.

As shown in FIG. 9, it is preferable that the speaker 40 is provided on the left side and the right side of the screen 40, respectively.

The screen 40 is disposed around the center of the upper part 11 of the front casing 10. An image is created with an image beam projected onto the backside of the screen 40, and a viewer can watch the image through the front part of the screen 40.

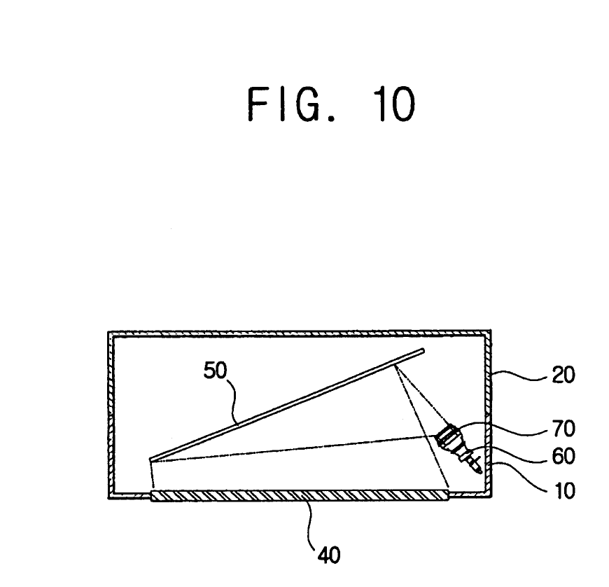

The reflector 50 (FIG. 10) is inclinedly disposed at the rear of the screen 40. The reflector 50 of the projection television retains the degree of inclination so that the image beams projected from the CRTs 60 disposed beside the screen 40 are reflected on the screen 40. In an aspect of the invention, the reflector 50 is almost vertically positioned, and then either of the left or right sides thereof is forwardly sloped toward the screen 40 and the other side of the reflector 50 is rearwardly sloped to the contrary.

FIG. 10 shows an embodiment of the present invention wherein the CRTs 60 are positioned in the right side of the screen 40, and shows an optical passage through which the image beams projected in the CRTs 60 are reflected by the reflector 50 and then projected onto the backside of the screen 40.

The CRTs 60 of the projection television according to an embodiment of the present invention employ the same CRTs as used in a conventional projection television. However, three CRTs according to the present invention are disposed vertically in order to solve the problem of distortion in force having been caused in the conventional projection television wherein the three CRTs have been disposed horizontally. Also, in the projection television according to the embodiments of the present invention, it is possible to dispose the CRTs 60 horizontally on the side of the screen 40.

The CRTs 60 can be positioned on either side of the screen 40. There is no separate space required to mount them since a space inherently provided on both sides of the screen 40 to mount the speaker 30 can be utilized.

FIG. 9 is a front elevational view showing a disposition of the CRT in the projection television according to an embodiment of the present invention, which is partially projected. From this figure, another embodiment of the present invention, wherein the three CRTs 60 vertically stacked on the side of the screen 40, is demonstrated.

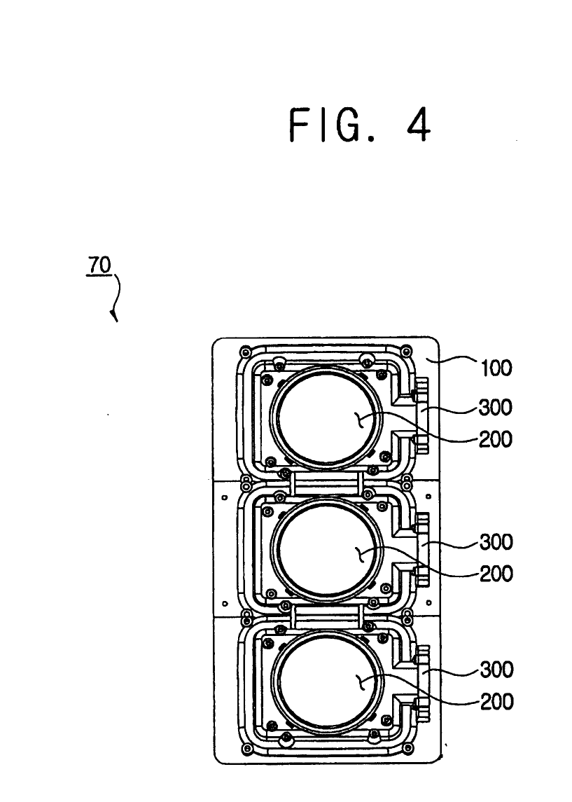

Referring to FIGS. 4 and 9, the CRTs 60 are constructed to be disposed vertically by stacking the plurality of CRTs vertically. Since the CRTs 60 are arranged in a different space from the PCB (not shown) provided in the inner bottom of the lower part 13 of the front casing 10, a functional problem due to heat generation from them can be prevented.

The CRT brackets 70 each includes a body part 100, a CRT inserting part 200 and a refrigerant inserting hole 300.

The body part 100 of the CRT bracket 70 is formed of a material strong enough to support the CRT 60.

The CRT inserting part 200 is projected from the body part 100, supportedly accommodating the CRT 60.

The refrigerant inserting hole 300 is formed on one side of the CRT inserting part 200, through which a refrigerant can be inserted. The refrigerant inserted into the refrigerant inserting hole 300 cools off components of the CRT 60 generating heat, thereby serving to minimize a functional problem of the CRTs 60 due to the heat generated.

The CRT brackets 70 are provided in plural so as to respectively support a plurality of CRTs 60. A plurality of CRT brackets 70 are preferably formed in an integrated unit. If the CRT brackets 70 are integrally made, there is no need to combine the respective CRT brackets 70 through a separate process. Also, the CRT brackets 70 can be completely closed.

Preferably, the plurality of CRT brackets 70 are shaped like stairs so that they are inclined to correspond with the angle of projection of the image beams from the plurality of CRTs 60.

The CRTs 60 in the projection television according to an embodiment of the present invention are provided in three so as to output the monochromatic color of red (R), green (G) or blue (B), and the CRTs are vertically disposed.

The image beams projected in the CRTs 60 are reflected on the reflector 50 having a width as designated, and are then projected on the screen 40. Therefore, it is preferable that the remaining CRTs 60 over and below the CRT 60 in the center are sloped toward the center, with the degree of angle as designated.

It is to be noted that visible rays refer to those having wave lengths in the region of the electromagnetic spectrum perceptible to human vision, among the electromagnetic waves. The modification of properties according to wave length within the visible rays is indicated by their proper colors.

In a case of the wave length of a monochromatic light, red is in the range of 700 to 610 nm, green is in the range of 570 to 500 nm, and blue is in the range of 500 to 450 nm.

Considering the vertical disposition of the plurality of CRTs 60 and the difference in wave length, it is preferable that the CRT brackets 70 according to the present invention are shaped like stairs.

It is to be noted that most electric and electronic apparatuses use electric energy to generate electromagnetic interference (EMI) to some degree, and this EMI likely brings about a malfunction in operation of the electric and electronic apparatuses or computer systems.

Thus, the CRT brackets 70 according to the present invention are preferably made of a metallic material having a conductivity.

By making the CRT brackets 70 of a metallic material having a conductivity, discharging of the EMI generated by the CRTs 60 to the outside is prevented, and also the discharging of the EMI generated from the outside into the CRT 60 can be prevented.

With this configuration, it is possible to lower the whole length of the projection television, secure the close combination of the CRTs, maintain the degree of angle or front and rear disposition of the CRTs and prevent functional problems due to electromagnetic waves.

As described above, the present invention can supply the following as well as other advantages.

In an aspect of the invention, the whole length of the projection television is lowered since the CRTs are disposed on the side of the screen.

In another aspect of the invention, the close combination of CRTs is secured by forming the CRT brackets in an integrated unit.

In yet another aspect of the invention, the degree of angle appropriate in disposing the plurality of CRTs and forward and rearward disposition thereof can be securely maintained because the CRT brackets are formed like stairs.

In still another aspect of the invention, a functional problem due to electromagnetic waves can be prevented because the CRT brackets are constructed so as to interrupt the EMI.

In still another aspect of the invention, mutual functional troubles due to heat generation between the CRT and the PCB can be prevented because they are disposed in different spaces.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A projection television, comprising:
a screen onto which an image beam is projected;
a reflector inclinedly disposed at the backside of the screen;
a plurality of CRTs disposed at a side of the screen, projecting the image beam toward the reflector; and
a plurality of CRT brackets including a body part, CRT inserting parts projecting from the body part and a refrigerant inserting hole formed on one side of the CRT inserting part, and supporting the plurality of CRTs.

2. The projection television according to claim 1, wherein the plurality of CRT brackets are formed in an integrated unit.

3. The projection television according to claim 1, wherein the plurality of CRT brackets are inclined in response to the degree of angle for projection of the image beam from the plurality of CRTs.

4. The projection television according to claim 2, wherein the plurality of CRT brackets are inclined in response to the degree of angle for projection of the image beam from the plurality of CRTs.

5. The projection television according to claim 1, wherein the plurality of CRT brackets are made of a conductive material to interrupt EMI.

6. A projection television, comprising:
a screen onto which an image beam is projected;
a reflector positioned at the backside of the screen vertically positioned with one of the left of right side of the reflector sloped toward the screen while the other of the left or right side of the reflector is sloped away from the screen;
a plurality of CRTs positioned at the side of the screen in which the reflector is sloped away from the screen to project the image beam toward the reflector; and
a plurality of CRT brackets each including a body part, a CRT inserting part projected from the body part and a refrigerant inserting hole formed on one side of the CRT inserting part, and supporting the plurality of CRTs.

7. The projection television according to claim 6, wherein the CRTs are positioned vertically.

8. The projection television according to claim 6, wherein the CRTs are positioned horizontally.

9. The projection television according to claim 6, wherein the plurality of CRTs brackets are of one integral unit in a stepped formation with respect to each other.

10. A projection television having a screen, a reflector, and a printed circuit board (PCB), the projection television comprising:
a plurality of CRTs to project the image beam toward the reflector; and
a plurality of CRT brackets integrally formed to support the CRTs, the CRT brackets being disposed at a predetermined distance from the PCB to prevent electromagnetic interference generated by the CRTs from affecting the PCB.

11. The projection television according to claim 10, wherein the plurality of CRT brackets are integrally formed to be shaped like stairs so that they are inclined to correspond with the angle of projection of the image beams from the plurality of CRTs.

12. The projection television according to claim 10, wherein the plurality of CRT brackets are made of a conductive material to interrupt EMI.

13. A projection television having a screen, a reflector, and a printed circuit board (PCB), the projection television comprising a plurality of CRTs to project the image beam toward the reflector, wherein the CRTs are positioned on the side of the screen.
